(19) United States
(12) Patent Application Publication
(10) Pub. No.: US 2024/0001926 A1
(43) Pub. Date: Jan. 4, 2024

(54) CONTROLLING A VEHICLE LANE-CHANGE

(71) Applicant: Ford Global Technologies, LLC, Dearborn, MI (US)

(72) Inventors: Baljeet Singh, Fremont, CA (US); Vladimir Ivanovic, Canton, MI (US); Hongtei Eric Tseng, Canton, MI (US); Bharaniprabha Malladi, Sunnyvale, CA (US); Pavan Kumar Gundu, San Jose, CA (US)

(73) Assignee: Ford Global Technologies, LLC, Dearborn, MI (US)

(21) Appl. No.: 17/852,900

(22) Filed: Jun. 29, 2022

(51) Int. Cl. B60W 30/18

(52) U.S. Cl. CPC B60W 30/18163; B60W 2552/10; B60W 2520/10; B60W 2554/802; B60W 2720/106

(57) ABSTRACT

Upon detecting a lane-change trigger to move an ego vehicle from a current lane to a target lane, a target vehicle is identified in the target lane. Then a set of candidate trajectories is built for the lane-change maneuver by, for each of the target vehicles in the target lane: determining a set of constraints for a lane-change maneuver based on current data collected in the ego vehicle, including speed and distance constraints for the ego vehicle, and adding to the set of candidate trajectories, from a stored set of trajectories, a candidate trajectory for the lane-change maneuver that satisfies the constraints for the lane-change maneuver. Upon determining that the set of candidate trajectories has been built for each of the target vehicles, an optimal trajectory is selected from the set of candidate trajectories. A longitudinal acceleration of the ego vehicle is commanded based on the optimal trajectory.

Vehicles can operate in various autonomous or semi-autonomous modes in which one or more components such as a propulsion, a brake system, and/or a steering system of the vehicle are controlled by a vehicle computer. The Society of Automotive Engineers (SAE) has defined multiple levels of autonomous vehicle operation. At Levels 0-2, a human driver monitors or controls the majority of the driving tasks, often with no help from the vehicle. For example, at Level 0 (“no automation”), a human driver is responsible for all vehicle operations. At Level 1 (“driver assistance”), the vehicle sometimes assists with steering, acceleration, or braking, but the driver is still responsible for the vast majority of the vehicle control. At Level 2 (“partial automation”), the vehicle can control steering, acceleration, and braking under certain circumstances without human interaction. At Levels 3-5, the vehicle assumes more driving-related tasks. At Level 3 (“conditional automation”), the vehicle can handle steering, acceleration, and braking, as well as monitoring of the driving environment, under certain circumstances. Level 3 requires the driver to intervene occasionally, however. At Level 4 (“high automation”), the vehicle can handle the same tasks as at Level 3 but without relying on the driver to take over in certain driving modes. At Level 5 (“full automation”), the vehicle can handle almost all tasks without any driver intervention or even present.

Various existing systems that can operate at Level 1 or above include systems such as adaptive cruise control, which can control velocity of a vehicle, including by adapting the velocity of the ego vehicle to one or more other vehicles; lane-centering, in which vehicle steering is controlled to maintain a lateral position of a vehicle in the center of a lane of travel; and lane-changing, in which a vehicle steering, acceleration, and/or braking can be controlled to move a vehicle from one lane of travel to another. Such systems may be referred to as Advanced Driver Assistance Systems (ADAS).

### BRIEF DESCRIPTION OF THE DRAWINGS

FIGS. 1A-1D illustrate traffic scenes with respective lane-change scenarios.

FIGS. 2A-2B illustrate traffic scenes with further respective lane-change scenarios.

FIG. 3 is a block diagram of an example vehicle system.

FIG. 4 illustrates an example lane-change control system that can be implemented in the vehicle system of FIG. 3.

FIG. 5 illustrates examples of different possible trajectories that could be generated for a vehicle in an s-v space (or domain) with respect to a target vehicle.

FIG. 6 illustrates an example grid in s-v space including test trajectories 505

FIG. 7 illustrates possible acceleration profiles for the test trajectories.

FIG. 8 illustrates a graph of accelerations for a test trajectory taking into account unknown parameters.

FIGS. 9A-9G show how test trajectories can be defined based on the various possible acceleration profiles illustrated in FIG. 7.

FIG. 10 illustrates an example of all possible test trajectories for an s-v grid generated according to the seven acceleration profile types illustrated in FIGS. 9A-9G.

FIG. 11 shows an example graph of an s-v space including a constrained region.

FIG. 12 includes a process flow diagram of an example process for a lane-change executed by the lane-change system of FIG. 4.

FIG. 13 is a graph illustrating adjusting lane-change parameters based on changes to a tuning parameter.

### DESCRIPTION

### Introduction

Described herein is lane-change control system for a vehicle, referred to as the “ego” vehicle because it is the vehicle with respect to which operations of the control system are performed. The lane-change control system may be referred to as a “longitudinal lateral coordinated control” (L2C2) system because it advantageously coordinates control of longitudinal velocities with lateral movement to improve trajectories of vehicles' automated lane-changes.

Accordingly, the present disclosure includes a system, comprising a computer for an ego vehicle including a processor and a memory, the memory storing instructions executable by the processor. The instructions include instructions to, upon detecting a lane-change trigger to move the ego vehicle from a current lane to a target lane, identify a target vehicle in the target lane. The instructions further include instructions to build a set of candidate trajectories for the lane-change maneuver by, for each of the target vehicles in the target lane: determining a set of constraints for a lane-change maneuver based on current data collected in the ego vehicle, including speed and distance constraints for the ego vehicle, and adding to the set of candidate trajectories, from a stored set of trajectories, a candidate trajectory for the lane-change maneuver that satisfies the constraints for the lane-change maneuver. The instructions further include instructions to, upon determining that the set of candidate trajectories has been built for each of the target vehicles, then select an optimal trajectory from the set of candidate trajectories. The instructions further include instructions to command a longitudinal acceleration of the ego vehicle based on the optimal trajectory.

The instructions can further include instructions to, upon determining that a completion time of the optimal trajectory matches a completion time specified for the lane-change maneuver, command the ego vehicle to perform the lane-change maneuver according to the optimal trajectory. The ego vehicle can execute the lane-change maneuver after the command to perform the lane-change maneuver. The instructions further include instructions to, upon a determination that the lane-change maneuver was not executed within the completion time following the command, re-identify the target vehicle or a new target vehicle in the target lane, build a new set of candidate trajectories, select a new optimal trajectory from the set of candidate trajectories, and command a new longitudinal acceleration of the ego vehicle based on the new optimal trajectory. The instructions further include instructions to, upon determining that a completion time of the new optimal trajectory matches a completion time specified for the lane-change maneuver, command the ego vehicle to perform the lane-change maneuver according to the optimal trajectory.

The candidate trajectories can generated based on respective scenarios that include an ego vehicle distance and speed from one the target vehicle, and/or by solving a system of simultaneous equations, and/or according to a trapezoidal acceleration profile, and/or according to static constraints including an acceleration constraint, and/or can be selected from respective sets of test trajectories that each define a final distance-velocity point. The static constraints can further include at least one of a speed, a final distance between the ego vehicle and the target vehicle, and a change of acceleration.

The optimal trajectory can be selected from the candidate trajectories by performing a discrete search of the candidate trajectories for the candidate trajectory that optimizes a cost function.

The instructions can further include instructions to, upon determining that the set of candidate trajectories is empty, adjust a tuning variable to adjust lane-change parameters to build the set of candidate trajectories.

A method comprises, upon detecting a lane-change trigger to move an ego vehicle from a current lane to a target lane, identifying a target vehicle in the target lane. The method further comprises building a set of candidate trajectories for the lane-change maneuver by, for each of the target vehicles in the target lane: determining a set of constraints for a lane-change maneuver based on current data collected in the ego vehicle, including speed and distance constraints for the ego vehicle, and adding to the set of candidate trajectories, from a stored set of trajectories, a candidate trajectory for the lane-change maneuver that satisfies the constraints for the lane-change maneuver. The method further comprises, upon determining that the set of candidate trajectories has been built for each of the target vehicles, then selecting an optimal trajectory from the set of candidate trajectories. The method further comprises commanding a longitudinal acceleration of the ego vehicle based on the optimal trajectory.

The method can further comprise, upon determining that a completion time of the optimal trajectory matches a completion time specified for the lane-change maneuver, commanding the ego vehicle to perform the lane-change maneuver according to the optimal trajectory. The ego vehicle can execute the lane-change maneuver after the command to perform the lane-change maneuver. The method can further comprise, upon a determination that the lane-change maneuver was not executed within the completion time following the command re-identifying the target vehicle or a new target vehicle in the target lane, building a new set of candidate trajectories; selecting a new optimal trajectory from the set of candidate trajectories; and commanding a new longitudinal acceleration of the ego vehicle based on the new optimal trajectory. The method can further comprise, upon determining that a completion time of the new optimal trajectory matches a completion time specified for the lane-change maneuver, commanding the ego vehicle to perform the lane-change maneuver according to the optimal trajectory.

The candidate trajectories can generated based on respective scenarios that include an ego vehicle distance and speed from one the target vehicle, and/or by solving a system of simultaneous equations, and/or according to a trapezoidal acceleration profile, and/or according to static constraints including an acceleration constraint, and/or can be selected from respective sets of test trajectories that each define a final distance-velocity point. The static constraints can further include at least one of a speed, a final distance between the ego vehicle and the target vehicle, and a change of acceleration.

The optimal trajectory can be selected from the candidate trajectories by performing a discrete search of the candidate trajectories for the candidate trajectory that optimizes a cost function.

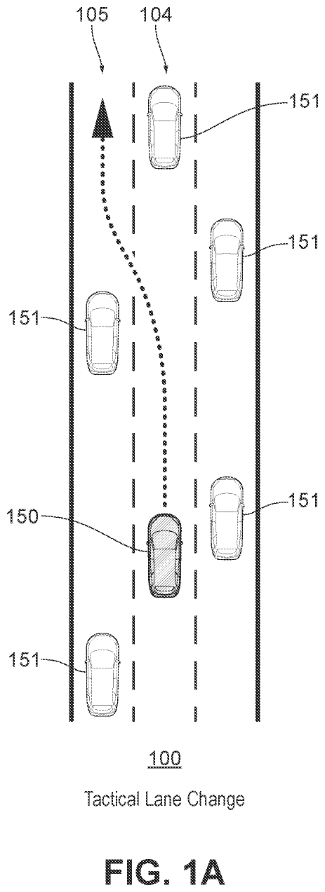

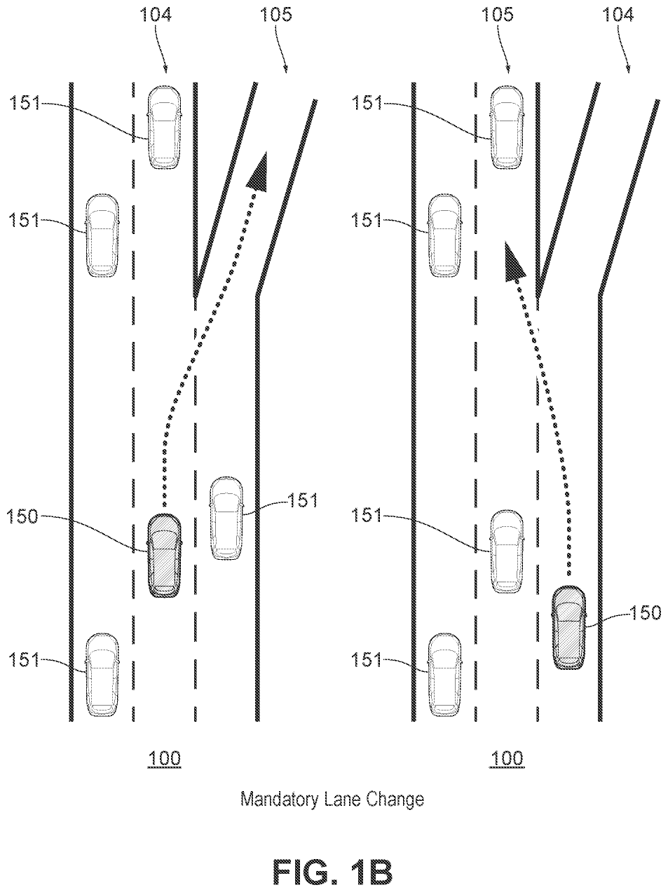

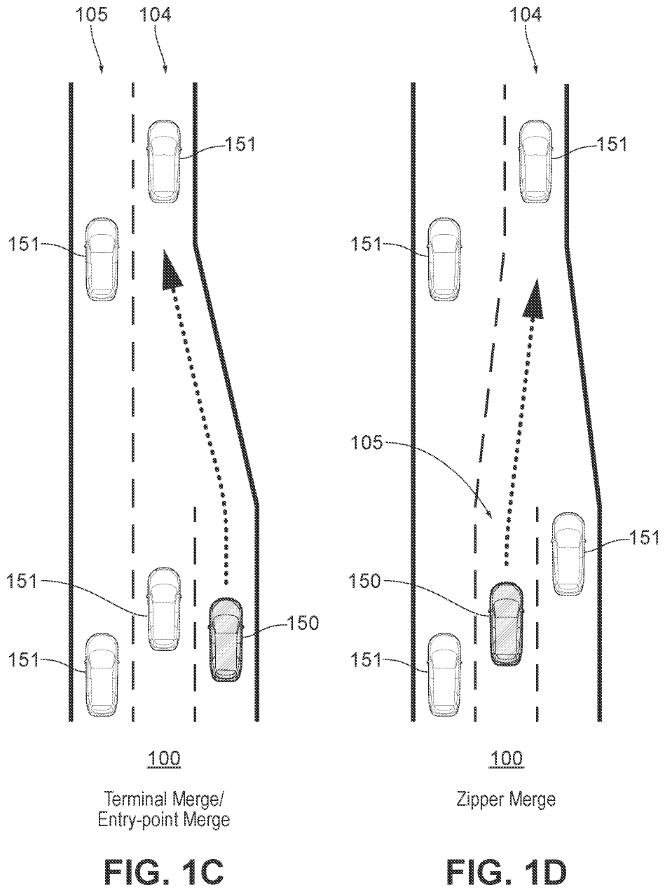

The lane-change control system can operate in various lane-change scenarios. FIGS. 1A, 1B, 1C, and 1D show respective traffic scenes 100 illustrating various lane-change scenarios in which an ego vehicle 150 can change from a current lane 150 to a target lane 105. As can be seen, the lanes 150, 105 can be occupied by other vehicles 151. FIG. 1A illustrates a tactical lane-change scenario, i.e., an ego vehicle 150 is moving from a current lane 104 to a target lane 105 after passing a target vehicle 151. In FIG. 1B, the two illustrated lane-change scenarios are referred to as “mandatory” because they are executed by an ego vehicle 150 to maintain a desired route of travel, e.g., to remain on or depart a current road of travel. FIGS. 1C and 1D illustrate merge scenarios that can be included in lane-changes addressed herein wherein two lanes of a vehicle road, including a current lane 150 reduces to one target lane 105; merge scenarios can be treated as mandatory lane-changes because, both cases, the ego vehicle 150 has to consider its trajectory with respect to vehicles 151 in a target lane 105 before transitioning to the target lane 105.

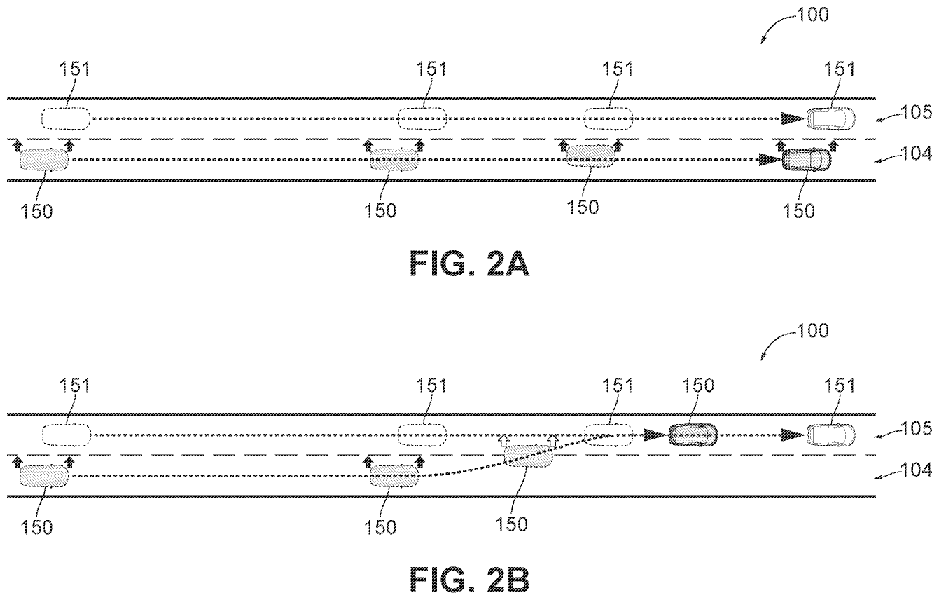

FIGS. 2A-2B illustrate traffic scenes 100 with further respective lane-change scenarios that can arise for a vehicle 150. The vehicles 150, 151 shown in cross-hatching represent the respective ego vehicle 150 and a second vehicle 151, sometimes referred to as a “target” vehicle, at time steps prior to a current time step. As seen in FIG. 2A, the ego vehicle 150 is attempting to execute a lane-change request from a current lane 150 to a target lane 105. However, due to overlapping lateral positions of the vehicles 150, 151, and similar speeds, the ego vehicle 150 is unable to find a gap in the target lane 105 into which it can move, and is unable to execute the lane-change. In FIG. 2B, the ego vehicle 150 initially experiences a lateral overlap with the target vehicle 151, but then adjusts its speed to move into the target lane 105 behind the target vehicle at 151. The present lane-change control system addresses the above scenarios by providing a trajectory according to which the ego vehicle 150 is commanded to move from a current lane 104 to a target lane 105 when a gap is available by adjusting ego vehicle 150 speed until a suitable gap is present, and when various other constraints, discussed in detail below, are satisfied.

The lane-change control system receives as input data about the ego vehicle including its current lane of travel and speed, a target lane (i.e., a lane to which the ego vehicle intends to move), target vehicles and a minimum time required to perform a lane-change. This data can be available on a vehicle network. For example, a minimum time to perform a lane-change can be provided from an existing lane-change control subsystem. Data about the ego vehicle can include ego vehicle physical states (or simply “states”) such as speed and yaw rate, provided by ego vehicle sensors and/or controllers. Data about target vehicles' states, such as their respective positions and speeds relative to the ego vehicle can be obtained from an ego vehicle computer that processes data from ego vehicle sensors. Using this input data, the lane-change control system can determine and then implement a trajectory for a lane-change. The present lane-change control system can improve vehicle lane-changes by providing a trajectory that reduces changes in acceleration and/or other undesirable attributes of a vehicle lane-change such as sudden or oscillatory changes in speed, acceleration, and/or steering.

The lane-change control system can receive a trigger to execute a lane-change. The trigger can be operator input and/or a determination by a computer of the ego vehicle. Upon receiving the trigger, the lane-change control system can consider relevant vehicles in a target lane, referred to herein as “target vehicles.” For each target vehicle, the lane-change control system considers test trajectories in a mathematical space (or domain) that is a relative distance-relative velocity space. This mathematical space is referred to herein as the s-v space (or domain), where s represents relative distance of an ego vehicle from a target vehicle, and v represents a relative speed or velocity of the ego vehicle with respect to the target vehicle. A time duration of test trajectories can be defined by the s-v grid, bounded by ego vehicle acceleration constraints. Then various constraints for a lane-change are evaluated by considering defined ego vehicle operating envelopes (i.e., permissible distances and velocities) relative to the leading and following vehicles. Trajectories having a duration larger than a predefined prediction horizon (e.g., 10-15 seconds), i.e., a predefined amount of time in a vehicle computer for which the vehicle computer is deemed capable of predicting events relevant to a lane-change, are rejected. Obtained admissible trajectories are stored. After storing admissible trajectories for all considered target vehicles, an optimal trajectory is found by minimizing a defined cost function. A first value of a longitudinal acceleration profile of the selected trajectory is then applied to the ego vehicle. When the final time of the selected optimal trajectory is equal to the required time for the vehicle to perform a lane-change, the lane-change control system commands a lane-change request.

### Vehicle System

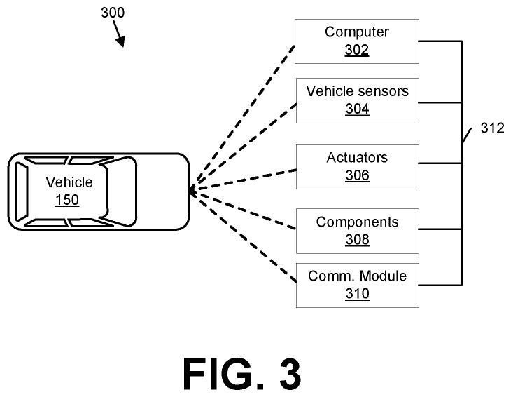

FIG. 3 illustrates an example system 300 implemented in a vehicle 150.

Vehicles 150 typically include one or more vehicle computers 302. A vehicle computer 302 (and any other computers discussed herein) includes a processor and a memory. The memory includes one or more forms of computer readable media, and stores instructions executable by the vehicle computer 302 for performing various operations, including as disclosed herein. For example, a vehicle computer 302 can be a generic computer with a processor and memory as described above and/or may include an electronic control unit (ECU) or controller for a specific function or set of functions, and/or a dedicated electronic circuit including an ASIC (application specific integrated circuit) that is manufactured for a particular operation, e.g., an ASIC for processing sensor data and/or communicating the sensor data. In another example, a vehicle computer 302 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in a computer. Certain operations herein may be ascribed to the vehicle computer 302, and is intended that such description encompass implementations in which the operations are carried out by more than one computer in a vehicle, e.g., by a first ECU providing data for a command to a second ECU that actuates one or more vehicle components 308.

The memory of a computer 302 can be of any type, e.g., hard disk drives, solid state drives, servers, or any volatile or non-volatile media. The memory can store the collected data sent from sensors 304 and/or other components 308. The memory can be a separate device from the computer 302, and the computer 302 can retrieve information stored by the memory via a network 312 in the vehicle 150, e.g., over a CAN bus, a wireless network, etc. Alternatively or additionally, the memory can be part of the computer 302, e.g., as a memory of the computer 302.

The computer 302 may include programming to command one or more actuators 306 to operate one or more vehicle 150 subsystems or components 308, such as vehicle 150 brakes, propulsion e.g., control of acceleration in the vehicle 150 by controlling one or more of an internal combustion engine, electric motor, hybrid engine, etc., steering, climate control, interior and/or exterior lights, etc., as well as to determine whether and when the computer, as opposed to a human operator, is to control such operations. Additionally, the computer may be programmed to determine whether and when a human operator is to control such operations. The computer may include or be communicatively coupled to, e.g., via a vehicle network 312 such as a communications bus as described further below, more than one processor, e.g., included in components 308 such as sensors, electronic control units (ECUs) or the like included in the vehicle 150 for monitoring and/or controlling various vehicle components, e.g., a powertrain controller, a brake controller, a steering controller, etc. The computer is generally arranged for communications on a vehicle 150 communication network 312 that can include a bus in the vehicle 150 such as a controller area network (CAN) or the like, and/or other wired and/or wireless mechanisms. Alternatively or additionally, in cases where the computer actually comprises a plurality of devices, the vehicle communication network 312 may be used for communications between devices represented as the computer 312 in this disclosure. Further, as mentioned below, various controllers and/or sensors may provide data to the computer 302 via the vehicle 150 communication network.

A vehicle 150 can include a plurality of sensors 304, i.e., various devices that provide analog and/or digital data measuring or describing physical phenomena. “Data” herein means information that can be processed and/or stored by a digital computer. Data can be provided and/or represented in a variety of formats, e.g., binary, hexadecimal, alphanumeric e.g., ASCII, etc. A sensor herein means a device that can obtain data including one or more measurements of one or more physical phenomena, including objects such as a target vehicle 151.

Vehicle sensors 304 and/or stationary sensors 304 could include cameras, lidar, radar, ultrasonic sensors, and various other sensors, including by way of example as described as follows. Some vehicle sensors detect internal states of the vehicle 150, for example, wheel speed, wheel orientation, and engine and transmission variables. Some vehicle sensors 304 detect the position or orientation of the vehicle 150, for example, global positioning system GPS sensors; accelerometers such as piezo-electric or microelectromechanical systems MEMS; gyroscopes such as rate, ring laser, or fiber-optic gyroscopes; inertial measurements units IMU; and magnetometers. Some sensors 304 detect the external world, for example, radar sensors, scanning laser range finders, light detection and ranging LIDAR devices, and image processing sensors such as cameras. A LIDAR device detects distances to objects by emitting laser pulses and measuring the time of flight for the pulse to travel to the object and back. Some sensors 304 are communications devices, for example, vehicle-to-infrastructure (V2I) or vehicle-to-vehicle (V2V) devices. Sensor operation can be affected by obstructions, e.g., dust, snow, insects, etc. Often, but not necessarily, a sensor 304 includes a digital-to-analog converter to converted sensed analog data to a digital signal that can be provided to a digital computer, e.g., via a network. Sensors 304 can include a variety of devices, and can be disposed to sense an environment, provide data about a machine, etc., in a variety of ways. For example, a stationary sensor 304 could be mounted to a stationary infrastructure element on, over, or near a road or area 106. Moreover, various controllers in a vehicle 150 may operate as vehicle sensors 304 to provide data via the vehicle network 312 or bus, e.g., data relating to vehicle 150 speed, acceleration, location, subsystem and/or component 308 status, etc. Further, other sensors 304 could include cameras, short range radar, long range radar, LIDAR, and/or ultrasonic transducers, weight sensors, accelerometers, motion detectors, etc., i.e., sensors to provide a variety of data. To provide just a few non-limiting examples, sensor data could include data for determining a position of a component 308, a location of an object, a speed of an object, a type of an object, a slope of a roadway, or surface of an area, a temperature, a presence or amount of moisture, a fuel level, a data rate, etc.

The vehicle computer 302 and vehicle sensors 304 and other devices such as actuators 306, a communication module 310, and/or other vehicle components 308 typically communicate via a vehicle network 312. A vehicle network 312 is a network via which messages can be exchanged between various devices in vehicle 150. Computer can be generally programmed to send and/or receive, via vehicle network 312, messages to and/or from other devices in vehicle 150 e.g., any or all of ECUs, sensors, actuators 306, components 308, communications module, a human machine interface HMI, etc. Additionally or alternatively, messages can be exchanged among various such other devices in vehicle 150 via vehicle network 312. In cases in which computer actually comprises a plurality of devices, vehicle network 312 may be used for communications between devices represented as computer in this disclosure. Further, as mentioned below, various controllers and/or vehicle sensors 304 may provide data to the computer.

In some implementations, vehicle network 312 can be a network in which messages are conveyed via a vehicle 150 communications bus. For example, vehicle network 312 can include a controller area 106 network CAN in which messages are conveyed via a CAN bus, or a local interconnect network LIN in which messages are conveyed via a LIN bus. In some implementations, vehicle network 312 can include a network in which messages are conveyed using other wired communication technologies and/or wireless communication technologies e.g., Ethernet, Wi-Fi®, Bluetooth®, etc. . Additional examples of protocols that may be used for communications over vehicle network 312 in some implementations include, without limitation, Media Oriented System Transport MOST, Time-Triggered Protocol TTP, and FlexRay™. In some implementations, vehicle network 312 can represent a combination of multiple networks, possibly of different types, that support communications among devices in vehicle 150. For example, vehicle network 312 can include a CAN in which some devices in vehicle 150 communicate via a CAN bus, and a wired or wireless local area 106 network in which some device in vehicle 150 communicate according to Ethernet or Wi-Fi communication protocols.

A vehicle component 308 is one or more hardware components 308 adapted to perform a mechanical or electro-mechanical function or operation—such as moving the vehicle 150, slowing or stopping the vehicle 150, steering the vehicle 150, etc. Non-limiting examples of components 308 include a propulsion component 308 (that includes, e.g., an internal combustion engine and/or an electric motor, etc.), a transmission component 308, a steering component 308 (e.g., that may include one or more of a steering wheel, a steering rack, etc.), a suspension component 308 (e.g., that may include one or more of a damper, e.g., a shock or a strut, a bushing, a spring, a control arm, a ball joint, a linkage, etc.), a brake component 308, a park assist component 308, an adaptive cruise control component 308, an adaptive steering component 308, one or more passive restraint systems (e.g., airbags), a movable seat, etc. Components 308 can include, or can be associated with, vehicle 150 actuators 306.

A vehicle actuator 306 can be implemented via circuits, chips, or other electronic and or mechanical components 308 that can actuate various vehicle 150 subsystems in accordance with appropriate control signals as is known. Actuators 306 may be used to control braking, acceleration, and steering of a vehicles 150. A vehicle computer 302 may be programmed to actuate vehicle actuators 306 including for propulsion, steering, and/or braking components 308.

A vehicle computer 302 may be configured for communicating via a vehicle communication module 310 or interface with devices outside of the vehicle 150 such as another vehicle 150, a mobile device of a user, a remote or stationary node computer 116. The communication module 310 can employ various suitable technologies and protocols, such as through vehicle-to-vehicle (V2V) communications, vehicle-to-infrastructure or everything V2X or vehicle-to-everything including cellular communications C-V2X wireless communications cellular, DSRC, etc. to another vehicle 150, to an infrastructure element typically via direct radio frequency communications and/or typically via the network a remote server. The module could include one or more mechanisms by which the computers of vehicles 150 may communicate, including any desired combination of wireless e.g., cellular, wireless, satellite, microwave and radio frequency communication mechanisms and any desired network topology or topologies when a plurality of communication mechanisms are utilized . Exemplary communications provided via the module can include cellular, Bluetooth, IEEE 802.11, dedicated short range communications DSRC, cellular V2X CV2X, and the like.

Vehicle computers 302 may further communicate via a wide area network (not shown). The wide area network can include one or more mechanisms by which a vehicle computer 302 may communicate with, for example, a remote server. Accordingly, the network can include one or more of various wired or wireless communication mechanisms, including any desired combination of wired e.g., cable and fiber and/or wireless e.g., cellular, wireless, satellite, microwave, and radio frequency communication mechanisms and any desired network topology or topologies when multiple communication mechanisms are utilized . Exemplary communication networks include wireless communication networks e.g., using Bluetooth, Bluetooth Low Energy (BLE), IEEE 802.11, vehicle-to-vehicle V2V or vehicle to everything (V2X) such as cellular V2X CV2X, Dedicated Short Range Communications DSRC, etc., local area networks (LAN) and/or wide area networks (WAN), including the Internet, providing data communication services.

### L2C2 System Architecture

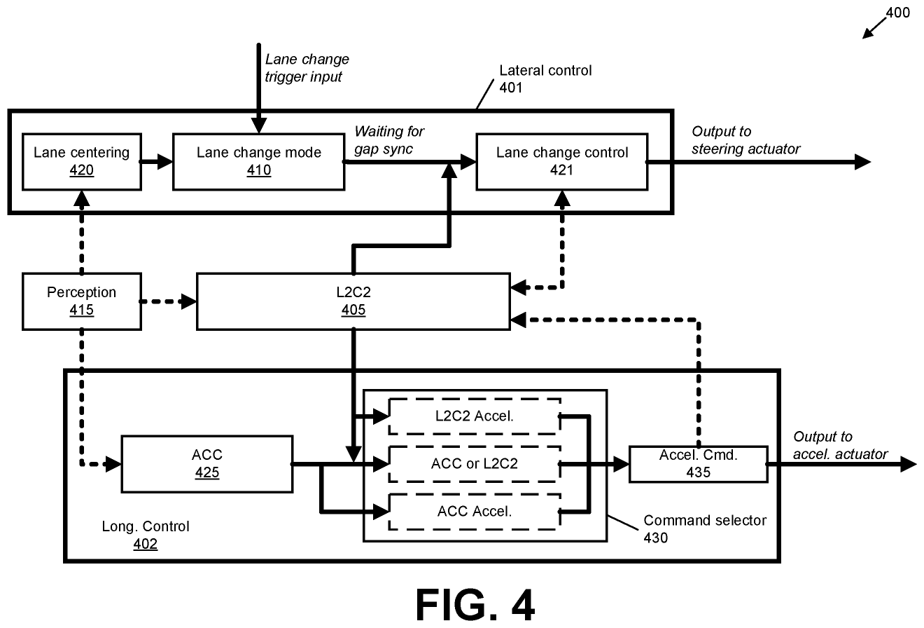

FIG. 4 illustrates an example L2C2 lane-change control system 400 that can be implemented in the vehicle system 300 of FIG. 3. The control system 400 can be implemented in one or more vehicle computers 302 that communicate with each other and/or with vehicle sensors 304, actuators 306, etc., via the vehicle network 312. The system 400 includes lateral longitudinal coordinated control (L2C2) block 405 to determine lane-change trajectories for control of a vehicle 150 lane-change. For convenience, dashed lines with arrows in FIG. 4 represent transfers of data, and solid lines with arrows represent commands, provided to and from the various blocks illustrated in FIG. 4, e.g., via a vehicle network 312.

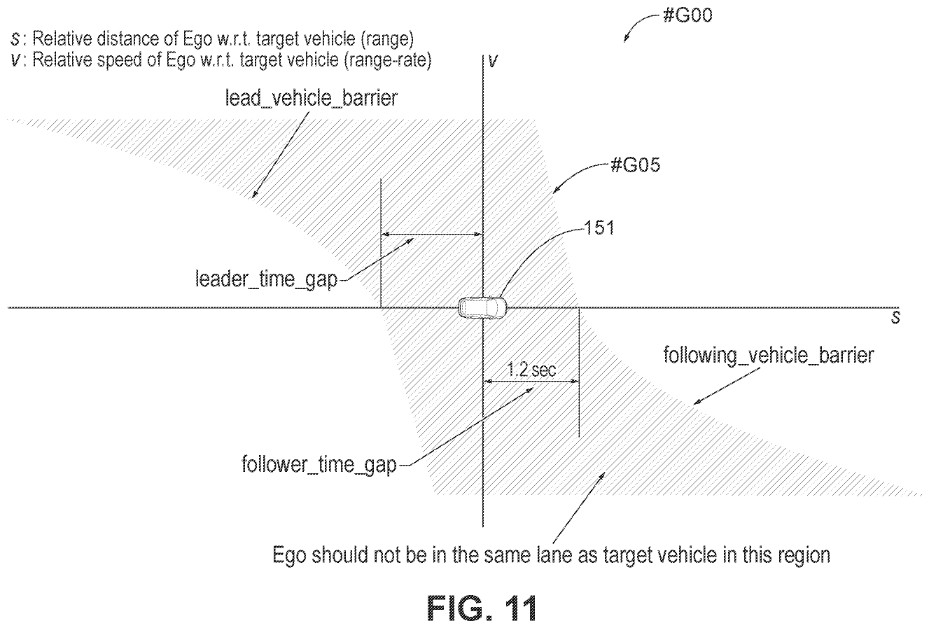

The lane-change control system 400 can be activated or triggered by a lane-change request, e.g., user input such as activating a vehicle 150 turn signal, or a decision by a vehicle computer 302 to change lanes. As explained further below with respect to FIG. 11, the L2C2 lane-change control system 400 typically remains active from the time the trigger is provided to a time at which the ego vehicle 150 process from a current lane 104 to a target lane 105, e.g., a time at which a center point of the vehicle 150 crosses a lane boundary.

The lane-change control system 400 includes lateral control block 401 and longitudinal control block 402, which can be provided respectively with existing ADAS features. For example, the lateral control block 401 can support lane-centering and/or lane-change features, and the longitudinal control block 402 can support adaptive cruise control (ACC) features. The lateral control block 401 can include a lane-change mode block 410 indicating whether a lane-change feature is on or active, as well as a lane-centering block 420 and/or a lane-change control block 425. The lateral control block 401 can provide output to a steering component 308 actuator 306, e.g., for lane-centering or lane-changing. The longitudinal control block 402 can include an ACC control block 425 whose output can be provided to a command selector block 430 provide an acceleration command 435 that is output to an accelerator component 308 actuator 306.

Perception block 415 represents vehicle sensors 304 provided via the vehicle network 312 to one or more vehicle computers 302 for vehicle 150 state data, data about target vehicles 151, etc., described further below. It will be understood that the perception block 415 can use various techniques to identify objects outside a vehicle 150 (e.g., target vehicles 151) and their locations. Accordingly, the perception block 415 provides localization data used by various ADAS features, including lane-centering provided by lateral control block 420, adaptive cruise control (ACC) provided via the longitudinal control block 425, as well as the lane-change control system 400.

Localization data in the context of this document means (a) data that measures or indicates a position, location, and/or pose of a vehicle 150 or some other object according to some coordinate system and/or relative to some other object, and (b) data about a physical state of a vehicle 150. For example, localization data could include a vehicle 150 location, i.e., vehicle 150 location data, e.g., specifying geo-coordinates or the like for a current vehicle 150 location. Localization data could also include a distance and/or relative heading (i.e., direction) of a vehicle 150 from some object, such as another vehicle 151, an intersection, a building, etc. Localization data could also include data about the pose of the vehicle 150 or some other object, i.e., an orientation of the vehicle 150 with respect to horizontal and/or vertical axes. The “physical state” of the vehicle 150 means a measurement or setting of the vehicle 150 describing or governing vehicle 150 movement. For example, a physical state of the vehicle 150 could include a vehicle 150 speed, acceleration, turn (or yaw) rate and/or heading, without limitation. A physical state of the vehicle 150 could further include settings such as a transmission setting (park, drive, reverse, etc.), a steering wheel angle, a state of engagement, e.g., brakes engaged or not engaged, etc. Further, references herein to a “location” of a vehicle 150 or some other object mean a place or position on a surface of the earth occupied by the object. A location can be specified according to a global coordinate system 100, e.g., geo-coordinates used by a Global Navigation Satellite System (GNSS), for example, sometimes referred to as GPS coordinates. Further, a location of an object such as another vehicle 151 could be specified with respect to a coordinate system relative to the host vehicle 150, e.g., a polar or Cartesian coordinate system with a point on the vehicle 150 as an origin. A location could alternatively or additionally be specified relative to some other object, e.g., as a distance and/or heading with respect to the other object.

The perception block 415 can determine a path for a vehicle 150 by specifying the path according to one or more path polynomials. A path polynomial is a polynomial function of degree three or less that describes the motion of a vehicle, i.e., from which locations of the vehicle 150 can be determined over time, on a ground surface. Motion of a vehicle on a roadway is described by a multi-dimensional state vector that includes vehicle location, orientation, speed, and acceleration. Specifically, the vehicle motion vector can include positions in x, y, z, yaw, pitch, roll, yaw rate, pitch rate, roll rate, heading velocity and heading acceleration that can be determined by fitting a polynomial function to successive 2D locations included in the vehicle motion vector with respect to the ground surface, for example.

Further for example, the path polynomial p(x) is a model that predicts the path as a line traced by a polynomial equation. The path polynomial p(x) predicts the path for a predetermined upcoming distance x, by determining a lateral coordinate p, e.g., measured in meters:

p(x)=a₀+a₁x+a₂x²+a₃x³

where a₀, an offset, i.e., a lateral distance between the path and a center line of the vehicle 105 at the upcoming distance x, a₁ is a heading angle of the path, a₂ is the curvature of the path, and a₃ is the curvature rate of the path.

When the system 400 is triggered, lane-change mode 410 is set to an active or ON status (as opposed to inactive, OFF, or standby). Perception block 415, lateral control block 401, and longitudinal control block 402 are typically already active when a lane-change is triggered, and/or may be activated.

As mentioned above, lateral control block 401 can include a lane-centering feature (block 420), which is an ADAS feature or the like that uses data from perception block 415 to maintain a vehicle 150 position in a current lane 104, e.g., at a center of the lane 104. The lateral control block 401 can also provide a lane-change control feature (block 421) using a requested as input from the perception block 415. Input to the lateral control block 401 from the perception block 415 typically includes a desired vehicle path, e.g., a path polynomial, determined based on data from vehicle sensors 304, e.g., image data that is processed by the perception block 415 to determine the desired vehicle path. Output of the lateral control block 401 is input to the steering component 308 actuator 306 to execute the intended lateral motion of the vehicle according to the desired vehicle path.

As further mentioned above, the longitudinal control block 402 can include ACC 425, which is an ADAS feature or the like that uses data from perception block 415 to maintain and/or control a vehicle 150 speed, including a vehicle 150 relative speed to other vehicles 151. The longitudinal control block 402 includes, e.g., typically as part of ACC 425, a target selection feature, e.g., to identify target vehicles 151. Output of the longitudinal control block 402 is input to acceleration component 308 actuator 306 (and/or braking component 308 actuator 306) to execute intended longitudinal motion of the vehicle according to the desired vehicle path.

L2C2 block 405 provides output to both of the lateral control block 401 and the longitudinal control block 402. With respect to the lateral control block 401, output from the L2C2 block 405 can be a command or signal to enable or disable (or activate or deactivate) the lane-change control block 421, e.g., a lane_change_enable flag. L2C2 block 405 can thereby prevent the ego vehicle 150 from making a lane-change when a target vehicle 151 gap is unavailable, and can actuate a lane-change when an appropriate gap between target vehicles 151 is available. With respect to the longitudinal control block 402, L2C2 block 405 provides commands or signals, discussed further below, including a use_ACC signal that specifies whether a command selector block 430 should select an acceleration command 435 based on output from an ACC 425 or the L2C2 block 405. The L2C2 block 405 can also output a specified acceleration value (l2c2_acceleration_value) based on a selected admissible trajectory such as described below.

### L2C2 Block Details

### Overview of L2C2 Processing

As described further below, the L2C2 block 405 includes programming to select a trajectory for a lane-change from a set of possible lane-change trajectories. The block 405 requires data about the ego vehicle 150, target lane 105, and one or more target vehicles 151. Further, the L2C2 block 405 receives as input, from the lane-change block 421, a minimum time required to perform a lane-change. The data input to the L2C2 block 405 includes data from the perception block 415, including data about the ego vehicle 150 including physical state data such as speed and yaw rate, and states of target vehicle(s) 151 states, including relative position and relative speed with respect to the ego vehicle 150.

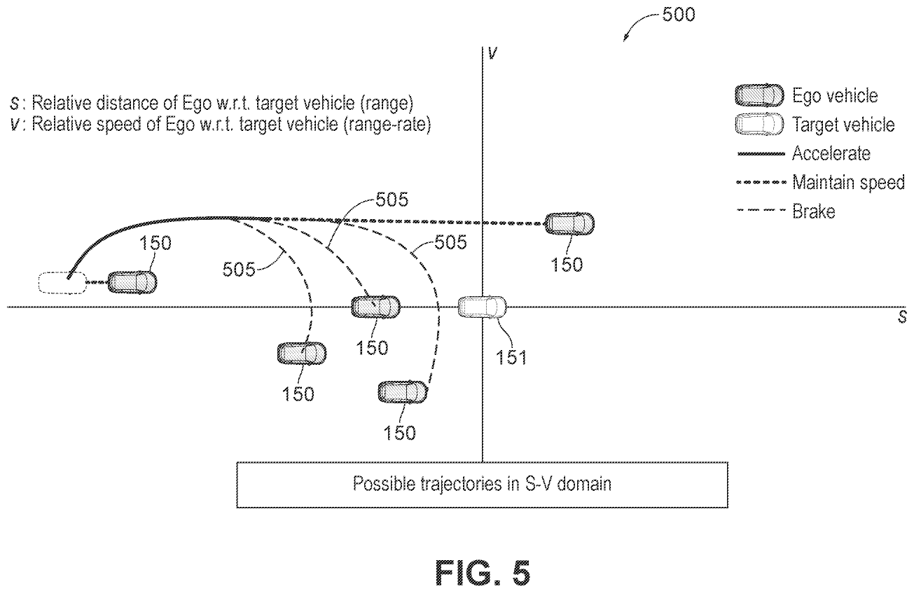

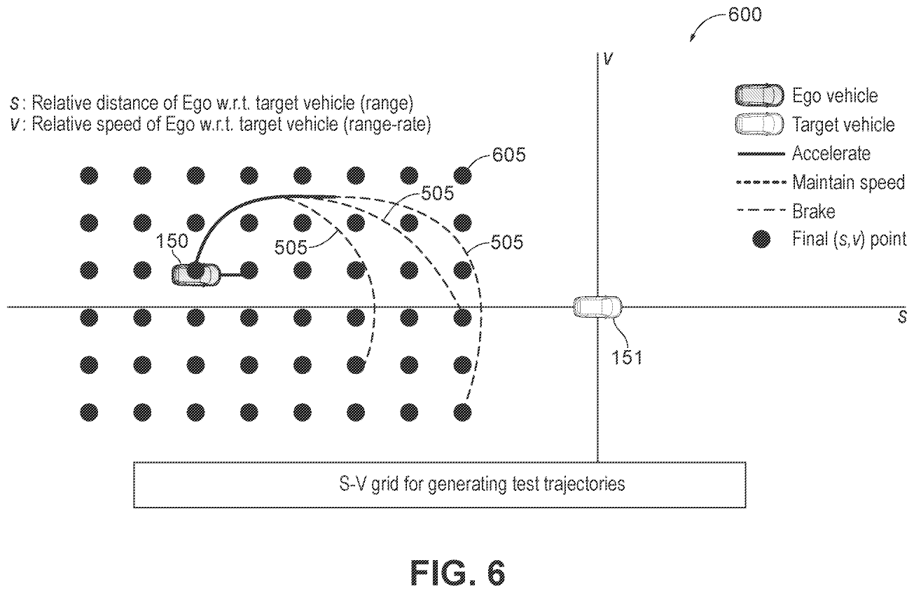

The L2C2 block 405 uses the data from the perception block 415 to consider each relevant target vehicle in the target lane. That is, for each identified target vehicle 151, test trajectories are generated in an s-v space for the target vehicle 151 (i.e., a domain defined based on a relative distance and a relative velocity of the ego vehicle 150 with respect to the target vehicle 151). Respective durations of the test trajectories are defined by an applicable s-v grid (discussed further below, e.g., with respect to FIGS. 5 and 6) and vehicle 150 acceleration constraints. Next, constraints, examples of which are provided below, are evaluated by considering time and/or distance envelopes relative to leading and following vehicles 151. Trajectories violating these constraints and also for which duration is larger than the predefined prediction horizon are rejected. Trajectories that are not rejected are referred to as “admissible trajectories,” and these may be stored in a memory of the computer 302. After generating and storing admissible trajectories for all considered target vehicles 151, an optimal trajectory is found that minimizes a defined cost function. Then a longitudinal control block 402 can actuate the ego vehicle 150 a first value of a selected trajectory. When the optimal final time (i.e., the duration of the optimal selected test trajectory) is equal to the required time for the vehicle 150 to perform a lane-change, the L2C2 block 405 commands the lane-change request. The L2C2 block 405 can continue its evaluation, and the system 400 can continue its operations, until the vehicle 150 changes lanes. Occurrence of the lane change is defined by the moment in time when the center of the vehicle 150 (defined by an intersection of longitudinal and lateral center axes of the vehicle 150) crosses a boundary of the current lane 104, whereupon the vehicle 150 enters the target lane 105.

### Lane-Change Parameters

The L2C2 block 405 uses certain parameters to govern a lane-change. In the context of this document, a parameter is a value representing a physical quantity that can be used to govern, limit, and/or constrain a process. Accordingly, a lane-change parameter is a value that can be used to govern, limit, and/or constrain a lane-change process. Put another way, lane-change parameters can be input values to the L2C2 block 405. Selection of a lane-change trajectory is governed or constrained by a set of parameters, for example as listed in Table 1 below:

TABLE 1

| ID | Parameter | Description |
|---|---|---|
| 1 | t_final | Maximum duration of lane-change trajectory |
| 4 | leader_decel_barrier | Maximum deceleration bound for distance |
| | | from front target 151 |
| 5 | leader_time_gap | Minimum time gap between ego vehicle |
| | | 150 and front target vehicle 151 |
| 6 | follower_time_gap | Minimum time gap between ego vehicle |
| | | 150 and front target vehicle 151 |
| 7 | delta_v_max | Maximum (+v_{ego}) relative speed |
| | | (i.e., max amount faster) from |
| | | front target 151 |
| 8 | delta_v_min | Maximum (−v_{ego}) relative speed |
| | | (i.e., max amount slower) from |
| | | front target 151 |
| 9 | v_grid_delta | Relative velocity grid width |
| 10 | s_grid_delta_t | Relative distance grid width |
| 11 | a_level | Maximum acceleration magnitude for |
| | | trapezoidal acceleration profiles |
| 12 | a_rate_limit | Acceleration change value for |
| | | trapezoidal acceleration profiles |
| 13 | set_speed_plus_delta | Maximum allowed speed increase |
| | | from set-speed |

### Lane-Change States

Further, the L2C2 block 405 stores state variables that include vehicle 150 physical states as well as settings pertaining to the current lane-change operation. In the context of this document, a “state” is a value of a variable representing a physical measurement and/or fact. Values of these variables may be provided from the perception block 415, e.g., based on vehicle path or route planning and/or data from vehicle sensors 304 and/or other components 308, and/or from user input, e.g., to trigger a lane-change. These can be defined in a data structure, for example the l2c2_state data structure that is illustrated below in Table 2.

TABLE 2

| ID | Variable | Description |
|---|---|---|
| 1 | l2c2_active | is L2C2 block 405 active, i.e., triggered |
| | | (binary, e.g., 0 or 1, yes-no) |
| 2 | target_cmd | target lane for which gap syncing is needed |
| | | (−1: left, 0: none, 1: right) |
| 3 | is_tactical | is the type of lane-change tactical |
| | | (binary, e.g., 0 or 1, yes-no) |
| 4 | is_mandatory | Is the lane-change mandatory |
| | | (binary, e.g., 0 or 1, yes-no) |
| 5 | is_terminal | is lane-change a terminal merge |
| | | (binary, e.g., 0 or 1, yes-no) |
| 6 | on_curve | is ego vehicle on a curve. This determination can |
| | | made based on the current lateral acceleration |
| | | experienced by the ego vehicle compared to a |
| | | certain threshold, e.g.,: |
| | | abs(veh_v_actleng_mps * vehyaw_w_actl) > 0.5 |
| 7 | d2tc | distance to approaching terminal point |
| | | (merge or mandatory lane-change; not used |
| | | or ignored if tactical lane-change) |
| 8 | v2tc | speed constraints at the approaching terminal point. |
| | | This is a 3 × 1 vector with the following values: |
| | | [max. speed at terminal point in current lane |
| | | min. speed in the current lane |
| | | max. speed at terminal point in target lane] |
| 9 | t2lc | time required to complete the lateral |
| | | lane-change maneuver. Here, the lane-change |
| | | is deemed complete when the center of the |
| | | ego vehicle crosses the lane boundary |
| 10 | set_speed | set-speed for used by ACC |

When the L2C2 state becomes active, e.g., l2c2_state. l2c2_active=1, then the L2C2 block 405 may identify, from data from the perception block 415, a list of target vehicles 151 (e.g., “target_vehicles”) for consideration with respect to generating lane-change trajectories. Typically, target vehicles 151 can be selected based on traveling in a target lane 105. That is, target vehicles 151 are selected where a value of l2c2_state.target_cmd is a lane in which the target vehicle 151 is currently traveling. The selected target vehicles 151 are then sorted according to their relative longitudinal distances from the ego vehicle 150 and stored in a list of target vehicles 151, e.g., a target_vehicles data structure. Nearest target vehicles 151 in the current lane 104 (i.e., based on longitudinal distances between the ego vehicle 150 and the respective target vehicles 151) are selected as current_leader and current_follower target vehicles 151.

### Trajectory Specifications and Constraints

The L2C2 block 405 generates a set of longitudinal trajectories (i.e., specifying speeds and/or accelerations over the time specified for the lane-change) for the ego vehicle 150 with respect to each of the target vehicles in the target_vehicles list. Thus, when reference is made herein to a trajectory or trajectories generated by the black 405, reference is made to such longitudinal trajectories, i.e., to a specification of speeds and/or accelerations over time, and not to other elements that may be typically thought of as included in a directory, such as a heading or position on a path.

FIG. 5 illustrates a graph 500 including examples of different possible or candidate trajectories 505 that could be generated for a vehicle 150 in an s-v space (or domain) with respect to a target vehicle 151. s is the relative distance of the ego vehicle 150 to a target vehicle 151, and v is the relative speed of the ego vehicle 150 to the target vehicle 151. The considered target vehicle 151 is set at the origin of the s-v space as illustrated in FIG. 5. To specify lane-change trajectories, initial values of s-v states (s0,v0) are known, i.e., as output from the perception block 415. Candidate lane-change trajectories are generated by specifying final values for a subset selected based on values of s, v, or time. A trajectory specification data structure can then be generated to specify these values, which can then be used to compute test trajectories as described further below. FIG. 6 illustrates an example grid in s-v space including test trajectories 505. Each of the (s,v) points 605 represents a possible vehicle 150 relative speed and distance with respect to the target vehicle 151.

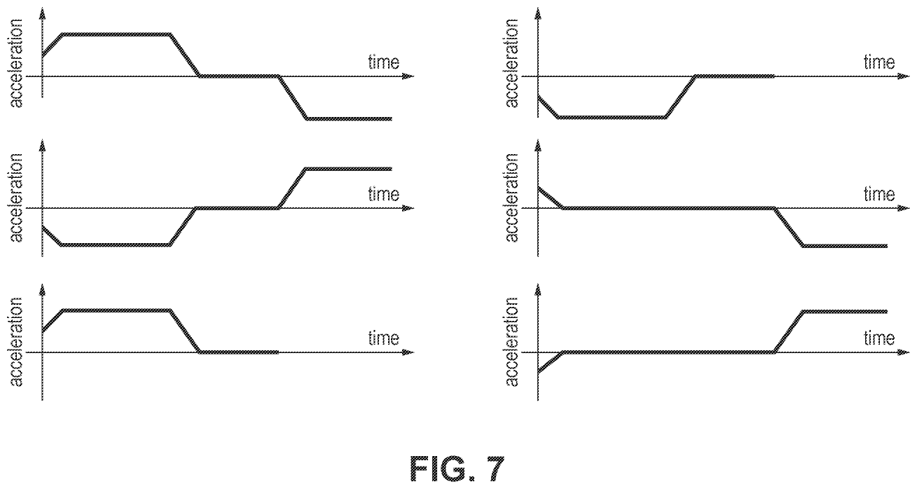

FIG. 7 illustrates possible acceleration profiles for the test trajectories. In examples discussed herein, as illustrated in FIG. 7, permissible acceleration profiles are trapezoidal. It has been found that trapezoidal acceleration profiles are advantageous for several reasons. First, the trapezoidal acceleration profile provides a more natural lane-change experience or vehicle occupants when the ego vehicle 150 is seeking to synchronize with a gap between target vehicles 151 (i.e., is adjusting its speed and/or position). Further, trajectories according to trapezoidal acceleration profiles can be represented using a relatively small number of parameters, and it is possible to determine trajectory parameters based on initial and final s-v values.

Moreover, as also seen in FIG. 7, to reduce a number of unknown variables, the L2C2 block 405 is typically programmed to use acceleration profiles with at most two trapezoid segments of opposite signs (i.e., positive and negative acceleration or acceleration and braking) separated with a zero-acceleration segment. Yet further as seen in FIG. 7, it is typically specified that all trapezoid segments have a same maximum height, and all have a same slope for these segments, i.e., change of acceleration show by the first derivative of acceleration, is to be maintained as close to a constant value as possible.

Test trajectories with respect to a target vehicle 151 can be generated based on one of the acceleration profiles illustrated in FIG. 7. The acceleration profiles have known fixed parameters or constraints: a (acceleration) and J (change of acceleration); and one known initial condition a₀ (initial acceleration). Based on the acceleration profiles defined as shown in FIG. 7, the L2C2 block 405 can specify any test trajectory with these known constraints and known initial condition, based on six unknown time parameters (t₁, t₂, t₃, t₄, t₅, t₆).

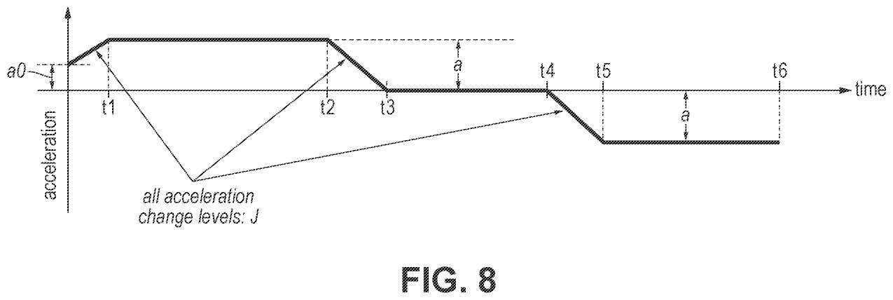

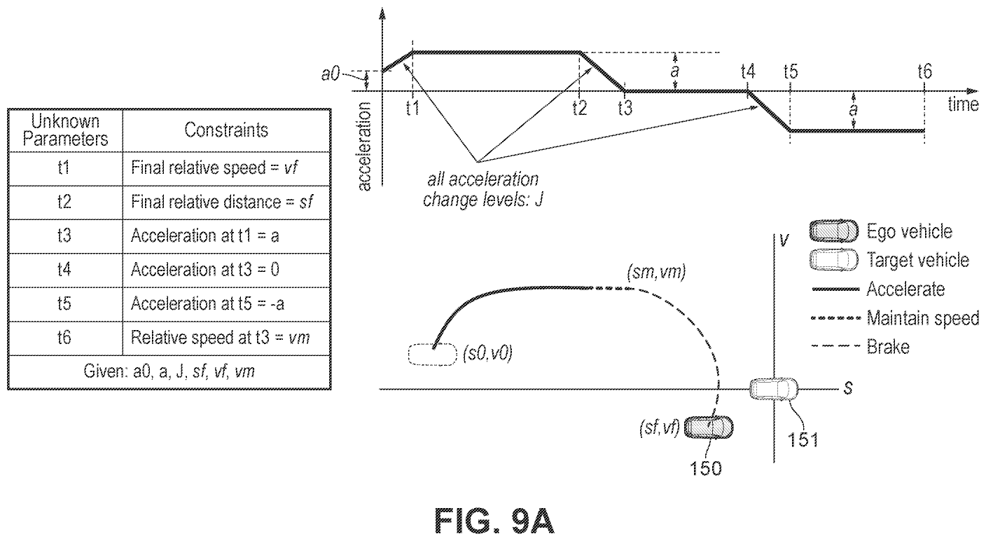

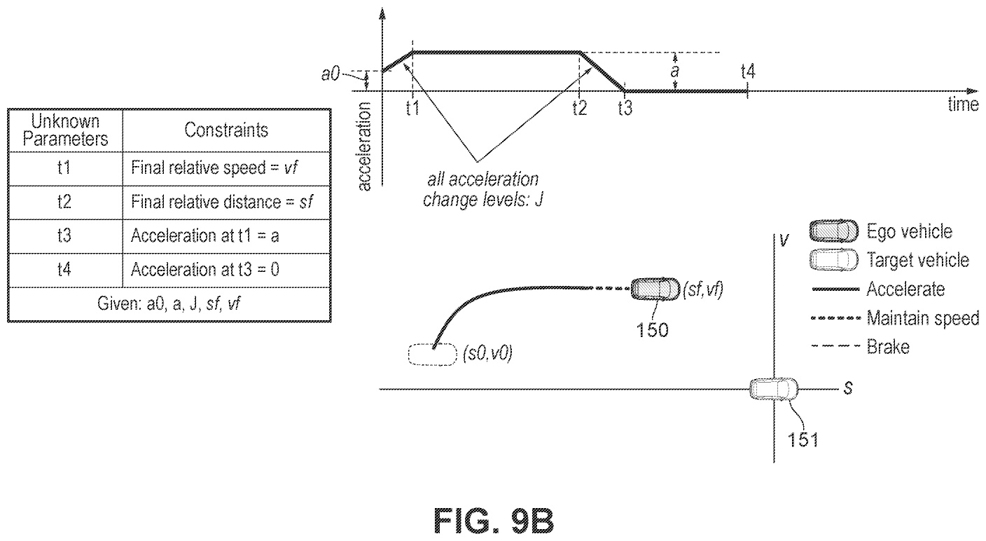

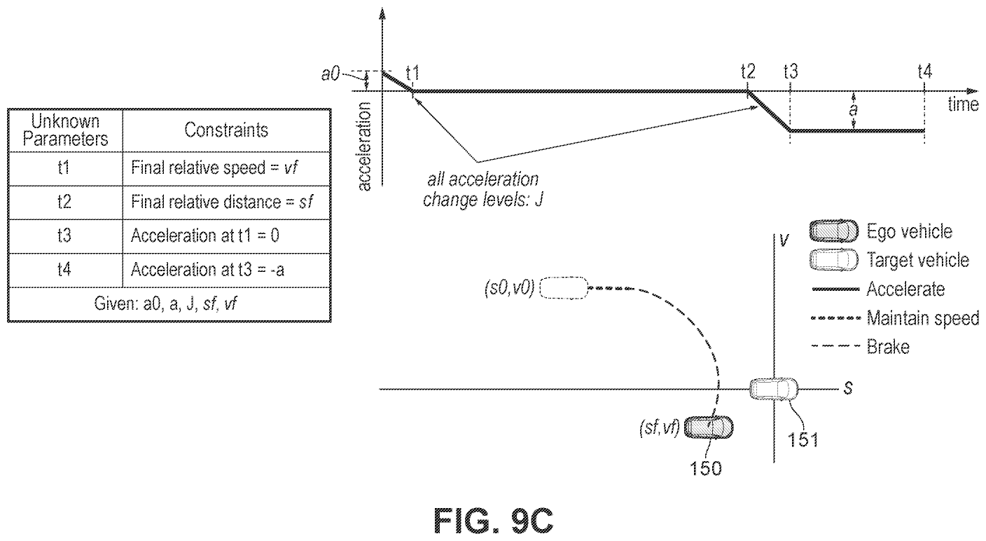

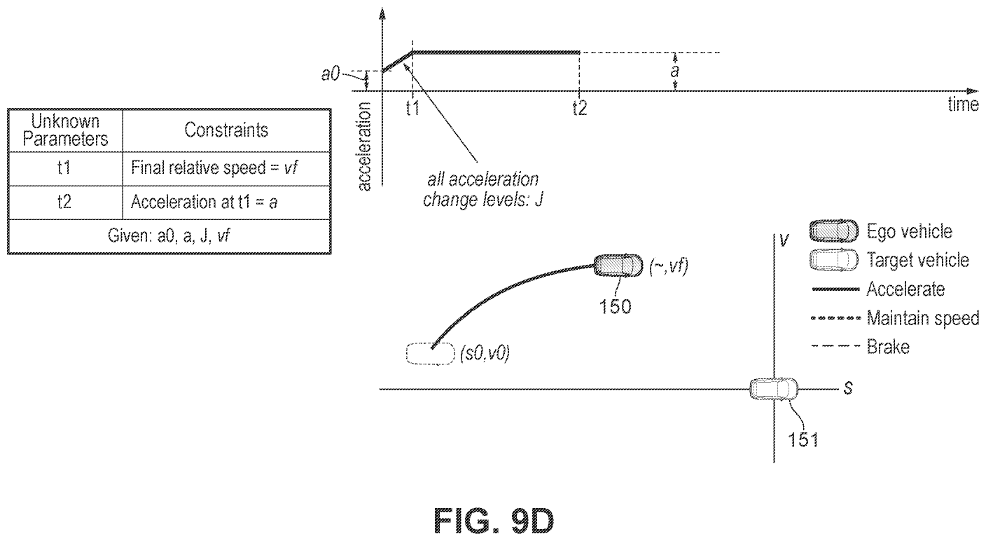

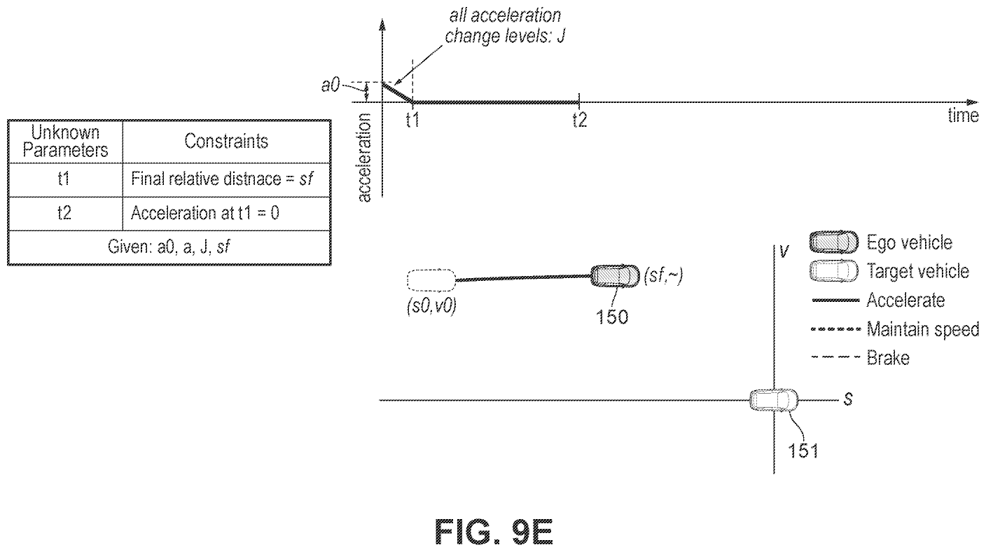

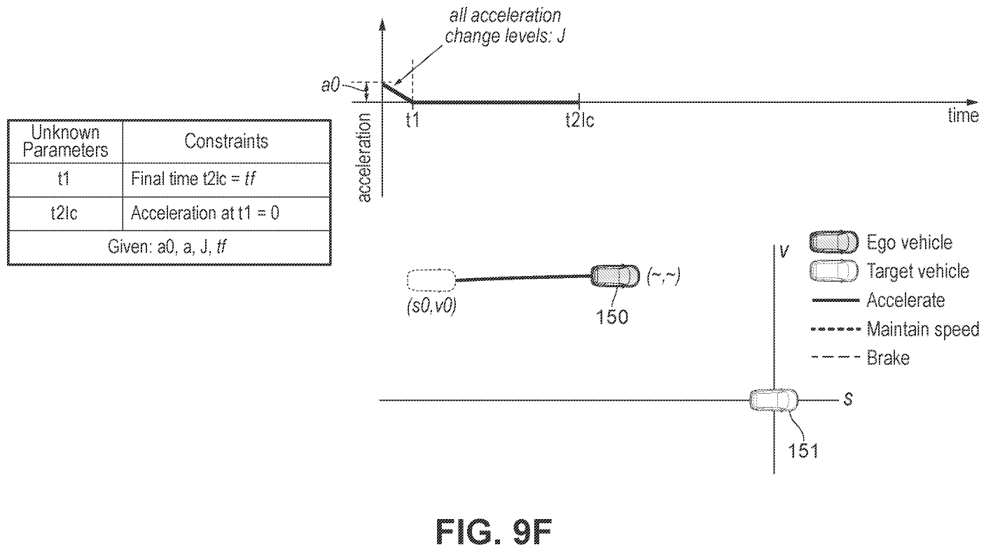

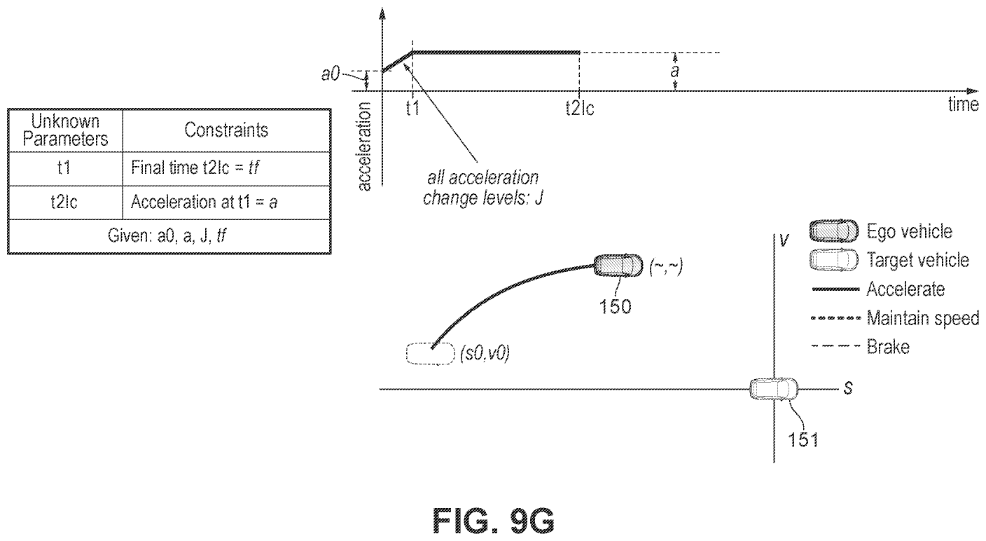

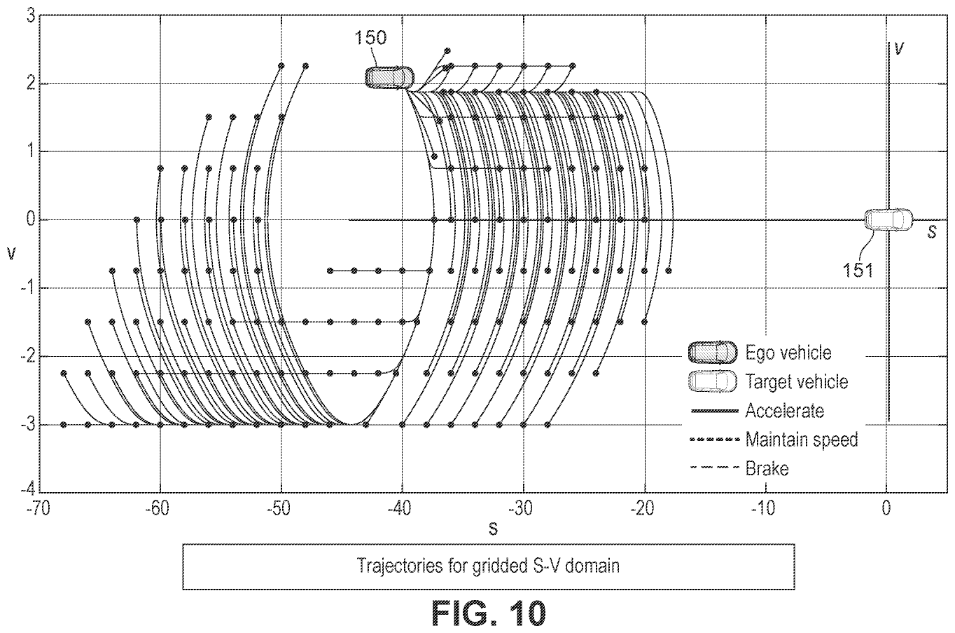

FIG. 8 illustrates a set of all test trajectories that can be generated for an s-v grid for one example set of initial conditions. FIGS. 9A-9G show how test trajectories can be defined based on the various possible acceleration profiles illustrated in FIG. 7. In each example, there are a number n of unknown time parameters, i.e., elapsed times from an initial time t₀. Further, for each type of trajectory, i.e., each one of the possible acceleration profiles, various constraints can be defined as illustrated. Inasmuch as the number of constraints defined in each example is equal to the number of unknown parameters, a system of simultaneous equations can be solved to determine using the unknown parameters, e.g., using the Symbolic Math Toolbox from MATLAB® by MathWorks®. FIG. 10 illustrates an example of all possible test trajectories for an s-v grid generated according to the seven acceleration profile types illustrated in FIGS. 9A-9G.

A trajectory specification defines initial and final values for a trajectory; there are other constraints that a trajectory should satisfy to be feasible for a lane-change maneuver. These include maximum acceleration limit, a maximum final time (i.e., maximum duration of the lane-change in over) and/or a minimum and/or maximum deviation from a set speed (e.g., being controlled by an ACC 425. A trajectory constraint data structure can be stored to provide trajectory constraint values such as the foregoing; these constraint values can then be used by a computer 302 to check feasibility of a given trajectory. Constraints may be assigned to all actors in a lane-change scenario, i.e., to a lead target vehicle 151, a following target vehicle 151, a current lead vehicle 151. Further, what are referred to as terminal trajectory constraints may be assigned, i.e., constraints defining end conditions, which are important for mandatory lane-changes and merges. That is, mandatory lane-changes and merges typically must be accomplished by a specified location.

### Scenario Constraints

In addition to trajectory constraints, a computer 302 can consider scenario constraints. These can include values such as a minimum permissible distance between any go vehicle 150 and a current lead vehicle 151, and minimum permissible distances between the ego vehicle 150 and target lead and following vehicles 151 when a lane-change maneuver completes. The foregoing minimum permissible distances are typically speed dependent, i.e., the distances increase as relative speeds between vehicles 150, 151 increase. FIG. 11 shows an example graph 1100 of an s-v space including a constrained region 1105. An envelope for an admissible trajectory may be defined as s-v points outside of the constrained region 1105. Put another way, an admissible trajectory will not violate constraints including the constrained region 1105.

To describe trajectory constraints, properties of various vehicles 150, 151 must be defined. In an example illustrated herein, the property definitions shown in Table 3 are used:

TABLE 3

| Property(ies) | Definition |
|---|---|
| v_{target}, v_{follower}, v_{current} | Target/follower/current |
| | leader 151 vehicle speed |
| y_{target, t}_{ₖ}, y_{follower, t}_{ₖ}, y_{current, t}_{ₖ} | Target/follower/current leader vehicle |
| | 151 distance from ego vehicle 150 at |
| | time tₖ , projected assuming a |
| | constant speed of the vehicle 151 |
| v_{ego, t}_{₆} | Ego vehicle 150 speed at final time t₆ |
| v_{ego, t}_{₃} | Ego vehicle 150 speed at final time t₃ |
| T_{leader}, T_{follower} | Permissible minimum time-gap for target |
| | leader/follower |
| a_{barrier} | Acceleration limit (or barrier) |

With these properties, various scenario constraints can be defined. These include lead target vehicle 151 constraints, which are applied only for a final or end point (i.e., location) of a trajectory:

y_{target,t}_{₆}−v_{target}T_{leader}>(v_{target}−v_{ego,t}_{₆})²/2a_{barrier}

Likewise, following target vehicle 151 constraints are applied only for a final or end point (i.e., location) of a trajectory:

−y_{follower,t}_{₆}−v_{follower}T_{follower}>(v_{follower}−v_{ego,t}_{₆})²/2a_{barrier}

Current lead vehicle 151 constraints can be applied both for a trajectory mid-points (t₃, t₄) and a final point (t₆):

y_{current,t}_{₆}−v_{current}T_{leader}>(v_{current}−v_{ego,t}_{₆})²/2a_{barrier}

y_{current,t}_{₃}−v_{current}T_{leader}>(v_{current} −v_{ego,t}_{₃})²/2a_{barrier}

y_{current,t}_{₄}−v_{current}T_{leader}>(v_{current}−v_{ego,t}_{₄})²/2a_{barrier}

Four terminal constraints can be specified based on d2tc and v2tc data as defined in Table 2 above:

$$d 2 t c > \frac{{( v 2 t c [ 1 ] - {v}_{ego , {t}_{6}} )}^{2}}{2 {a}_{b a r r i e r}}$$

$${v}_{ego , {t}_{3}} > v 2 t c [ 2 ]$$

$${v}_{ego , {t}_{6}} > v 2 t c [ 2 ]$$

$$d 2 tc > \frac{{( v 2 t c [ 3 ] - {v}_{ego , {t}_{6}} )}^{2}}{2 {a}_{b a r r i e r}}$$

### Trajectory Costs and Optimizations

Once generated, a test trajectory can be assigned a cost, e.g., as follows:

$$J = {t}_{6} + {K}_{1} \frac{d}{{v}_{0}} + {K}_{2} abs ( {t}_{6} - {t}_{6 , p r e v} ) ,$$

where K₁, K₂ are constants, t₆ is the trajectory, t_{6,prev} is the final time of an optimal trajectory in a prior iteration (as explained below with respect to Figure_), and

d=abs(y₆−(y₆−(y_{6,prev}+v_{target}(t₃−t_{3,prev})))

where y₆ is the total longitudinal displacement of the trajectory, y_{6,prev} is the longitudinal displacement of the optimal trajectory in the last iteration, v_{target} is the velocity of the target vehicle, and d is a variable that captures a discontinuity in a planned behavior of a vehicle 150, i.e., change in expected location and/or speed, whereupon the optimal solution in two consecutive iterations can jump from a front of a target vehicle 151 to behind it, or vice-versa.

Because test trajectories can be efficiently computed based on defining an s-v grid and parameters as explained above, i.e., a trajectory can be represented with 6 parameters and computed, costs can further be efficiently determined. Therefore, it is possible to employ a discrete search to find the optimal trajectory, i.e., the test trajectory having a minimum cost minimum cost.

### Example Processes

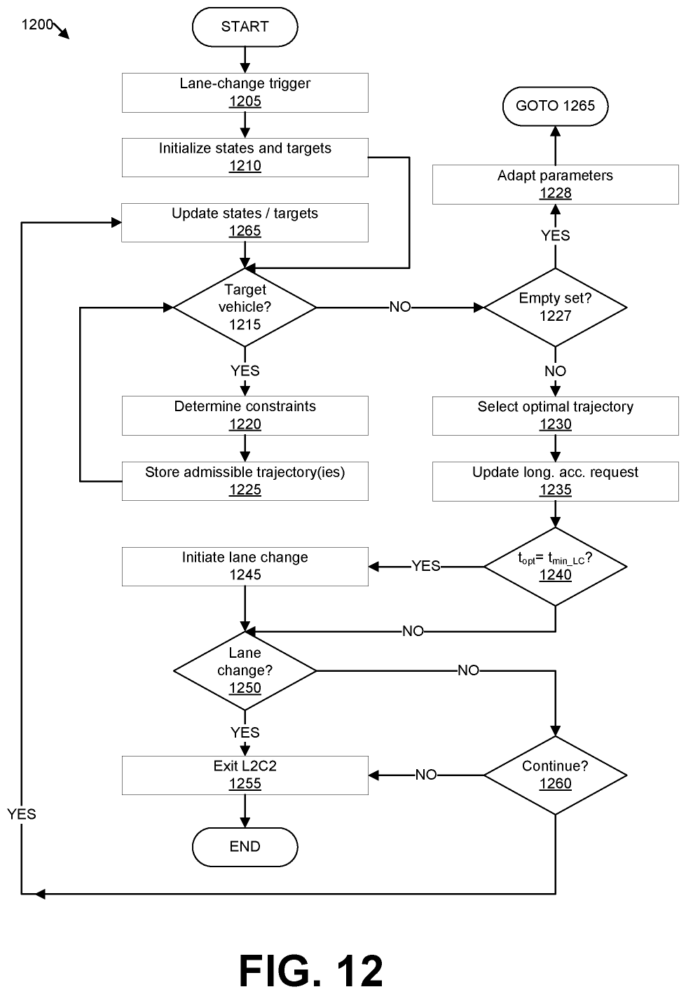

FIG. 12 includes a process flow diagram of an example process 1200 for a lane-change executed by the lane-change system 400, i.e., by one or more vehicle 150 computers 302. The process 1200 begins in a block 1205, in which the lateral control block 401 receives a lane-change trigger, e.g., input from a virtual driver, actuation of a turn signal, etc., whereupon a lane-change mode 410 becomes active, is in an ON status, etc.

Next, in a block 1210, the vehicle computer 302 initializes states relevant for the lane-change. For example, the vehicle computer 302 can load lane-change parameters, e.g., as described above concerning Table 1, and also can initialize, i.e., create and populate with initial values, an l2c2_state data structure such as is shown above in Table 2. The vehicle computer 302 can further create a list of target vehicles, e.g., the target_vehicles list discussed above. Data to initialize the states and list of target vehicles may be provided from user input and/or the perception block 415. For example, the perception block 415 may provide data identifying target vehicles 151 in a current lane 104 and/or a target lane 105, along with locations and relative speeds of respective target vehicles 151. Following the block 1210, the process 1200 proceeds to a block 1220.

In a block 1215, the computer 302 determines whether any target vehicles 151 remain in the target vehicle list for which admissible trajectories have not yet been determined. If yes, then a block 1220 is executed next. If no, then a block 1227 is executed next.

In a block 1220, which may follow the block 1215, the computer 302 determines constraints for selecting admissible trajectories with respect to the target vehicle 151 currently under consideration, i.e., trajectory and scenario constraints discussed above.

Following the block 1220, in a block 1225, the computer 302 stores one or more admissible trajectories, if any. The admissible trajectories can be referred to as candidate trajectories because they are candidates, i.e. possible trajectories, for a lane-change. Following the block 1225, the process 1200 returns to the block 1215.

In a block 1227, which may follow the black 1215, the computer 302 determines whether at least one admissible trajectory (sometimes also referred to as a feasible trajectory) has been found. Put another way, the computer 302 determines whether the set of admissible trajectories is an empty set. If yes, then a block 1228 can be executed next. Otherwise, a block 1230 may be executed next.

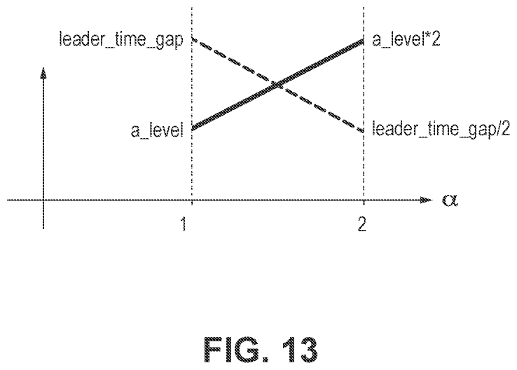

In the black 1228, the computer 302 can adapt lane-change parameters to facilitate finding and admissible trajectory. In one example, two parameters illustrated in Table 1, leader_time_gap and a_level_are adjusted according to a tuning parameter α. FIG. 13 illustrates the tuning parameter or variable α increasing from an initial value of “1” to a value of “2,” thus increasing the likely hood that the system 400 will find a solution to achieve a lane-change. Put another way, the tuning parameter α allows the system 400 to adaptively seek tighter gaps within permissible constraints, including permissible vehicle acceleration and/or deceleration. For each iteration of the blocks 1215-1227 for which no admissible trajectory is found, α is increased based on a pre-defined rate (e.g., in increments of 1) for the next cycle, until at least one admissible trajectory is found or α reaches a value to 2, at which point the process 1200 may terminate after the block 1227 (although not shown in FIG. 12), and the system 400 may return vehicle 150 control, e.g., to ACC 425.

The block 1230 may be executed following the block 1227 upon a determination that all target vehicles in the target vehicle list have been processed, i.e., no target vehicles are remaining to be processed. In the block 1230, the computer 302 can perform a discrete search to select an optimal trajectory from the admissible trajectories stored in the block 1225, e.g., according to a cost function as described above.

Following the block 1230, in a block 1235, the computer 302 updates a longitudinal acceleration request, i.e., in the context of the control system 400, the L2C2 block 405 outputs an L2C2 acceleration request to the command selector block 430.

Next, in a block 1240, the computer 302 determines whether the duration of the optimal test trajectory (which can be referred to as the optimal final time tₒₚₜ) is equal to the required time for the vehicle to perform a lane-change (t21c), the computer 302 commands a lane-change request, and proceeds to a block 1245. Otherwise, the process 1200 proceeds to a block 1250.

In the block 1250, the computer 302 determines whether a lane-change has been completed. If yes, the process 1200 proceeds to a block 1255. Otherwise, the process 1200 proceeds to a block 1260.

In the block 1255, the computer 302 deactivates or exits the L2C2 system 400, and the process 1200 ends.

In the block 1260, the computer 302 determines whether to continue the process 1200. For example, a trigger could be received to terminate the process, such as a virtual driver providing a determination not to change lanes, input from an operator such as deactivation of the turn signal, etc. If the process 1200 is not to continue, the process 1200 proceeds to the black 1255. Otherwise, the process 1200 proceeds to a block 1265, in which the states and a list of target vehicles determined in the black 1210 are updated, whereupon the process 1200 returns to the block 1215.

### CONCLUSION

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, unless indicated otherwise or clear from context, such processes could be practiced with the described steps performed in an order other than the order described herein. Likewise, it further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

The adjectives first and second are used throughout this document as identifiers and, unless explicitly stated otherwise, are not intended to signify importance, order, or quantity.

The term exemplary is used herein in the sense of signifying an example, e.g., a reference to an exemplary widget should be read as simply referring to an example of a widget.

Use of in response to, based on, and upon determining herein indicates a causal relationship, not merely a temporal relationship.

Computer executable instructions may be compiled or interpreted from computer programs created using a variety of programming languages and/or technologies, including, without limitation, and either alone or in combination, Java, C, C, Visual Basic, Java Script, Perl, HTML, etc. In general, a processor e.g., a microprocessor receives instructions, e.g., from a memory, a computer readable medium, etc., and executes these instructions, thereby performing one or more processes, including one or more of the processes described herein. Such instructions and other data may be stored and transmitted using a variety of computer readable media. A file in a networked device is generally a collection of data stored on a computer readable medium, such as a storage medium, a random access memory, etc. A computer readable medium includes any medium that participates in providing data e.g., instructions, which may be read by a computer. Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

1. A system, comprising a computer for an ego vehicle including a processor and a memory, the memory storing instructions executable by the processor to:
upon detecting a lane-change trigger to move the ego vehicle from a current lane to a target lane, identify a target vehicle in the target lane;
build a set of candidate trajectories for the lane-change maneuver by, for each of the target vehicles in the target lane:
determining a set of constraints for a lane-change maneuver based on current data collected in the ego vehicle, including speed and distance constraints for the ego vehicle, and
adding to the set of candidate trajectories, from a stored set of trajectories, a candidate trajectory for the lane-change maneuver that satisfies the constraints for the lane-change maneuver;
upon determining that the set of candidate trajectories has been built for each of the target vehicles, then select an optimal trajectory from the set of candidate trajectories; and
command a longitudinal acceleration of the ego vehicle based on the optimal trajectory.

2. The system of claim 1, the instructions further including instructions to:
upon determining that a completion time of the optimal trajectory matches a completion time specified for the lane-change maneuver, command the ego vehicle to perform the lane-change maneuver according to the optimal trajectory.

3. The system of claim 2, wherein the ego vehicle executes the lane-change maneuver after the command to perform the lane-change maneuver.

4. The system of claim 2, the instructions further including instructions to, upon a determination that the lane-change maneuver was not executed within the completion time following the command, re-identify the target vehicle or a new target vehicle in the target lane, build a new set of candidate trajectories, select a new optimal trajectory from the set of candidate trajectories, and command a new longitudinal acceleration of the ego vehicle based on the new optimal trajectory.

5. The system of claim 4, the instructions further including instructions to:
upon determining that a completion time of the new optimal trajectory matches a completion time specified for the lane-change maneuver, command the ego vehicle to perform the lane-change maneuver according to the optimal trajectory.

6. The system of claim 1, wherein the candidate trajectories are generated based on respective scenarios that include an ego vehicle distance and speed from one the target vehicle.

7. The system of claim 1, wherein the candidate trajectories are selected from respective sets of test trajectories that each define a final distance-velocity point.

8. The system of claim 1, wherein the candidate trajectories are generated according to static constraints including an acceleration constraint.

9. The system of claim 8, wherein the static constraints further include at least one of a speed, a final distance between the ego vehicle and the target vehicle, and a change of acceleration.

10. The system of claim 1, wherein the candidate trajectories are generated according to a trapezoidal acceleration profile.

11. The system of claim 1, wherein the candidate trajectories are generated by solving a system of simultaneous equations.

12. The system of claim 1, wherein the optimal trajectory is selected from the candidate trajectories by performing a discrete search of the candidate trajectories for the candidate trajectory that optimizes a cost function.

13. The system of claim 1 the instructions further including instructions to, upon determining that the set of candidate trajectories is empty, adjust a tuning variable to adjust lane-change parameters to build the set of candidate trajectories.

14. A method, comprising:
upon detecting a lane-change trigger to move an ego vehicle from a current lane to a target lane, identifying a target vehicle in the target lane;
building a set of candidate trajectories for the lane-change maneuver by, for each of the target vehicles in the target lane:
determining a set of constraints for a lane-change maneuver based on current data collected in the ego vehicle, including speed and distance constraints for the ego vehicle, and
adding to the set of candidate trajectories, from a stored set of trajectories, a candidate trajectory for the lane-change maneuver that satisfies the constraints for the lane-change maneuver;
upon determining that the set of candidate trajectories has been built for each of the target vehicles, then selecting an optimal trajectory from the set of candidate trajectories; and
commanding a longitudinal acceleration of the ego vehicle based on the optimal trajectory.

15. The method of claim 14, further comprising:
upon determining that a completion time of the optimal trajectory matches a completion time specified for the lane-change maneuver, commanding the ego vehicle to perform the lane-change maneuver according to the optimal trajectory.

16. The method of claim 15, wherein the ego vehicle executes the lane-change maneuver after the command to perform the lane-change maneuver.

17. The method of claim 15, further comprising, upon a determination that the lane-change maneuver was not executed within the completion time following the command
re-identifying the target vehicle or a new target vehicle in the target lane, building a new set of candidate trajectories;
selecting a new optimal trajectory from the set of candidate trajectories; and
commanding a new longitudinal acceleration of the ego vehicle based on the new optimal trajectory.

18. The method of claim 17, further comprising:
upon determining that a completion time of the new optimal trajectory matches a completion time specified for the lane-change maneuver, commanding the ego vehicle to perform the lane-change maneuver according to the optimal trajectory.

19. The method of claim 14, wherein the candidate trajectories are generated based on respective scenarios that include an ego vehicle distance and speed from one the target vehicle.

20. The method of claim 14, wherein the candidate trajectories are at least one of (a) selected from respective sets of test trajectories that each define a final distance-velocity point, or (b) generated according to static constraints including an acceleration constraint.
